(19) United States
(12) Patent Application Publication
(10) Pub. No.: US 2012/0312132 A1
(43) Pub. Date: Dec. 13, 2012

(54) ELECTRONIC TORQUE APPARATUS EQIPPED WITH AN AUTOMATIC COMPENSATION DEVICE WITH OUTPUT TORQUE

(76) Inventors: Ming-Hua Li, Taichung City (TW); Hsiu Chiang, Miaoli County (TW)

(21) Appl. No.: 13/480,789

(22) Filed: May 25, 2012

(30) Foreign Application Priority Data
Jun. 10, 2011 (TW) 100120315

(51) Int. Cl. B25B 23/144

(52) U.S. Cl. 81/479

(57) ABSTRACT

An electronic torque apparatus equipped with an automatic compensation device with output torque includes an electronic torque wrench with a changeable drive head, a plurality of drive heads at varying lengths and an automatic compensation device in the electronic torque wrench with built-in output torque. One of the drive heads is selected to be installed on the electronic torque wrench as desired. Through the automatic compensation device, compensation is set and calculated according to the type or length of the drive head so that operation torque of the electronic torque wrench and preset target torque are equal to actual output torque of the electronic torque wrench. Thereby users can directly and instantly get the actual output torque on a display element without calculation or conversion through tables to improve reliability and usability.

### FIELD OF THE INVENTION

The present invention relates to a torque wrench and particularly to a torque wrench that provides automatic compensation torque.

### BACKGROUND OF THE INVENTION

Please refer to FIG. 1, a conventional torque wrench with a to changeable drive head includes a torque bar 2, a display element 3, a torque detection element 4 and a control system 5. When in use it is coupled with a drive head 1. While the drive head 1 is used to fasten a screw head (not shown in the drawings), the torque detection element 4 located on the torque bar 2 detects deformation amount of the torque bar 2, and the control system 5 calculates output torque corresponding to the deformation amount of the torque bar 2 so that the output torque is displayed through the display element 3 for users.

Referring to FIG. 2, the drive head 1 is a standard one of the torque wrench. When a torque T is applied to fasten a screw head (not shown in the drawings) via a screw coupling head 6, the torque detection element 4 detects the corresponding standard deformation amount of the torque bar 2, and the control system 5 calculates a standard torque value corresponding to the torque T.

Also referring to FIG. 3, in order to meet operation requirements, different types of the drive heads 1A are needed in different environments. As the drive heads 1A are respectively formed in a size different from that of the standard drive head 1, the distance L1A between the screw coupling head 6 and the force applying center (as shown in FIG. 3) is different from the distance L1 on the standard drive head 1 (as shown in FIG. 2). Hence even if the same torque T is applied to the torque wrench equipped with the standard drive head 1 and another torque wrench equipped with the drive head 1A, the deformation amounts of the torque bar 2 at the detection element 4 are different. The torque values calculated by the control system 5 also are different. This causes users cannot perform fastening well since an operation torque applied by the users is different from the actual output torque.

In order to make the actual output torque of the torque wrench satisfy accuracy to meet use requirements, when different types of the drive heads 1 and 1A are used, a torque conversion formula of the torque wrench has to be utilized to convert the intended output torque into the required operation torque of the torque wrench. The required operation torque of the torque wrench generally is different from the intended output torque.

The aforesaid conventional operation approach is quite inconvenient in use. Users have to calculate and convert the operation torque first to operate correctly. Moreover, as different types of the drive heads 1 and 1A on the market are in use, it is also difficult to make accurate measurement to the lengths thereof, and calculation mistakes also may occur. As the operation torque and actual output torque value are different, users cannot be instantly aware of the fastening status of screws. All these create a lot of problems. There are still rooms for improvement.

### SUMMARY OF THE INVENTION

Therefore, the primary object of the present invention is to provide an electronic torque apparatus equipped with an automatic compensation device with output torque that can automatically correct torque errors caused by change of different drive heads and avoid serious mistake caused by human calculation errors. In the present invention, various types of the drive heads are fabricated in advance at different lengths with numbers or specific symbols formed thereon, and varying compensation modes also are preset corresponding to the different drive heads through the automatic compensation device so that when users desire to change the drive head they can quickly select or set the corresponding compensation mode via the automatic compensation device, thereby not only the operable output torque range of the electronic torque wrench can be undated instantly the users also can set a value the same as an intended output target torque and be informed in the event that the intended output target torque exceeds the updated operable output torque range. Moreover, during operation of the electronic torque wrench, as instantly displayed torque value on a display element is the same as instantly output torque value, the users can be informed instantly the correct operation torque and use the electronic torque wrench freely.

To achieve the foregoing object, the electronic torque apparatus equipped with an automatic compensation device with output torque according to the present invention includes an electronic torque wrench with a changeable drive head, a plurality of drive heads at varying lengths and an automatic compensation device in the electronic torque wrench with built-in output torque. One of the drive heads is selected to be installed on the electronic torque wrench as desired. Through the automatic compensation device with the output torque that can set and calculate compensation according to the type or length of the drive head, not only the operable output torque range of the electronic torque wrench can be undated instantly, users also can set a value the same as the intended output target torque and be informed in the event that the intended output target torque exceeds the updated operable output torque range. During operation of the electronic torque wrench, as instantly displayed torque value on the display element is the same as instantly output torque value, human calculation or conversion through tables can be omitted, hence reliability and usability improve. In addition, as various types of the drive heads are pre-fabricated at different lengths with numbers or specific symbols formed thereon, and varying compensation modes corresponding to the drive heads are also built in the automatic compensation device, when different types of the drive heads are changed as desired, users can quickly select a corresponding compensation mode via the automatic compensation device, hence the torque wrench can be used quickly and correctly.

In short, in the invention, when different drive heads are changed as desired, a corresponding compensation mode can be selected or set through the automatic compensation device. Through automatic compensation of the automatic compensation device, a torque applied to the screw can be the same as a preset target torque value. Therefore users do not need to do conversion via the formula. Usability improves. The risk of conversion error also can be averted. Moreover, the automatic compensation via the automatic compensation device allows the instantly displayed torque value of the wrench to be the same as the instantly output torque value, thus the users can be instantly informed of the correct operation torque and use the wrench more freely.

The foregoing, as well as additional objects, features and advantages of the invention will be more readily apparent from the following detailed description, which proceeds with reference to the accompanying embodiments and drawings. The embodiments merely serve for illustrative purpose and are not the limitations of the invention.

### BRIEF DESCRIPTION OF THE DRAWINGS

FIG. 1 is a schematic view of a conventional torque wrench.

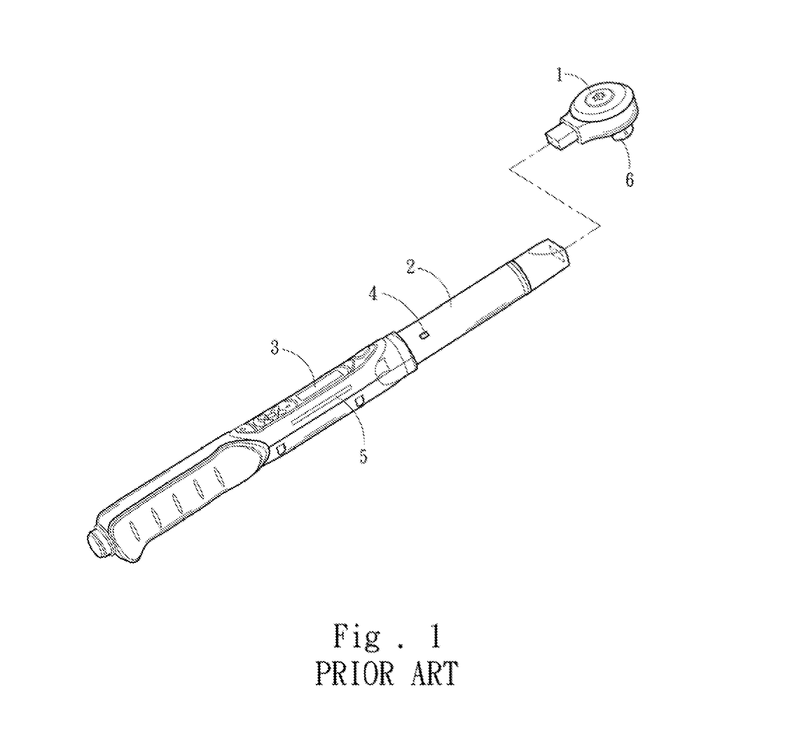

FIG. 2 is a schematic view of a conventional torque wrench coupled with a drive head.

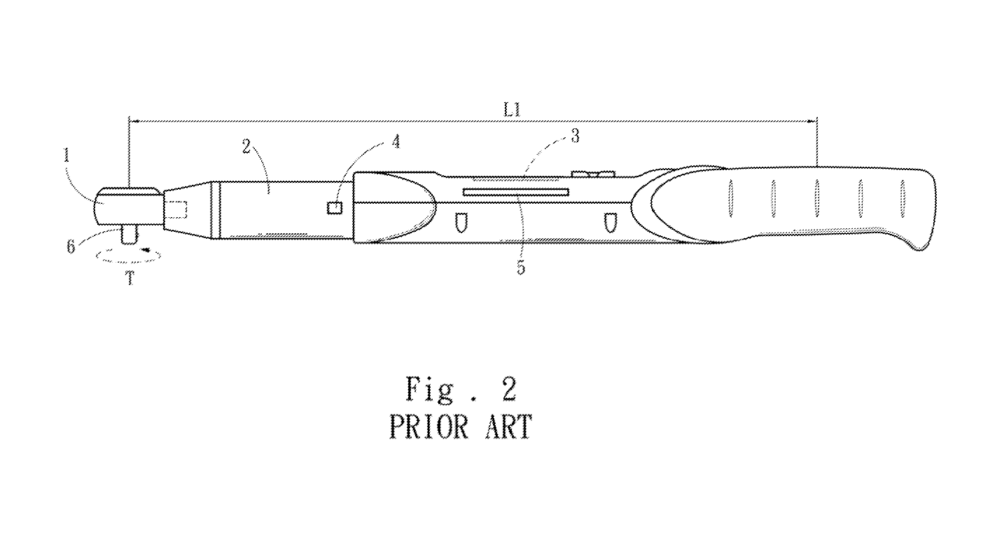

FIG. 3 is a schematic view of a conventional torque wrench coupled with another drive head.

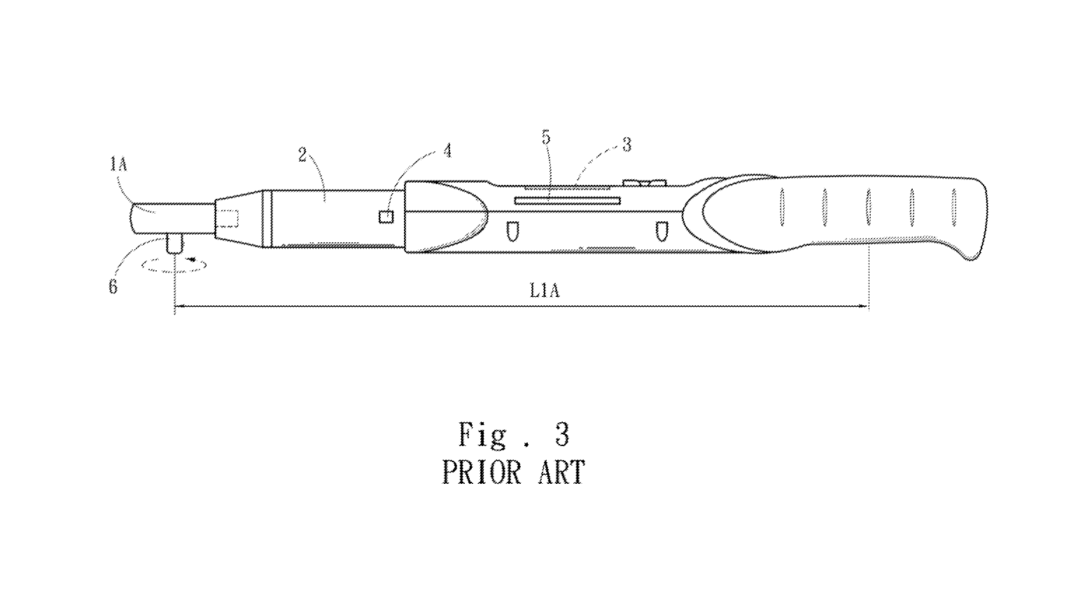

FIG. 4 is a schematic view of the torque wrench of the invention.

FIG. 5 is a schematic view of the torque wrench of the invention coupled with different drive heads at varying torque lengths.

FIG. 6 is an operation flowchart of the invention.

FIG. 7 is another operation flowchart of the invention.

FIG. 8 is a simplified operation flowchart of the invention.

FIG. 9 is another simplified operation flowchart of the invention

### DETAILED DESCRIPTION OF THE PREFERRED EMBODIMENTS

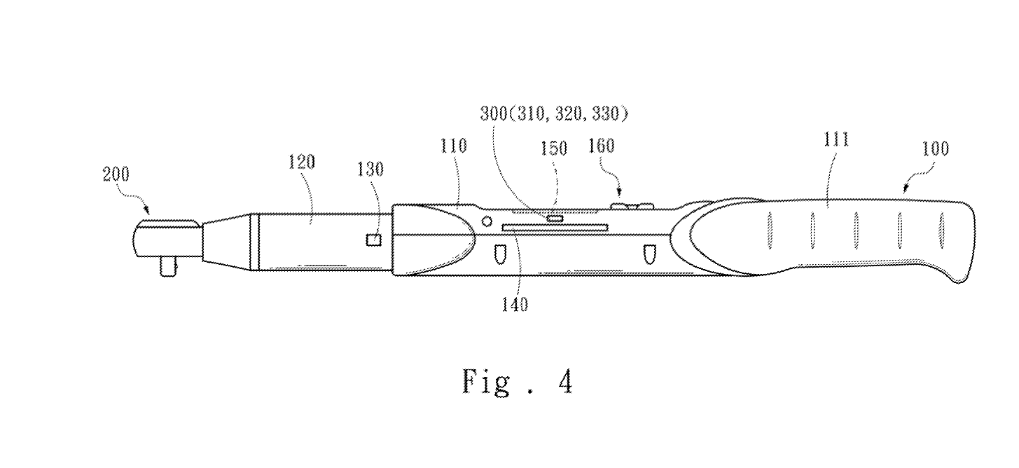

Please refer to FIG. 4, the present invention aims to provide an electronic torque apparatus equipped with an automatic compensation device with output torque. It includes at least one changeable drive head 200, an electronic torque wrench 100 with the changeable drive head 200 and an automatic compensation device 300.

The electronic torque wrench 100 includes a housing 110, a torque bar 120, a torque detection element 130, a control system 140, a display element 150 and a setting element 160. The housing 110 has a handgrip 111 to be grasped by a user. The torque bar 120 has one end running through and coupling with the housing 110. The torque detection element 130 is located on the torque bar 120 to detect deformation amount of the torque bar 120. The control system 140 is located in the housing 110 and electrically connected to the torque detection element 130 to calculate forces applied to the electronic torque wrench 100 corresponding to the deformation amount of the torque bar 120. The display element 150 is electrically connected to the control system 140 and displays the calculated forces applied to the electronic torque wrench 100. The setting element 160 is located on the housing 110 and electrically connected to the control system 140 to set related operation parameters of the electronic torque wrench 100.

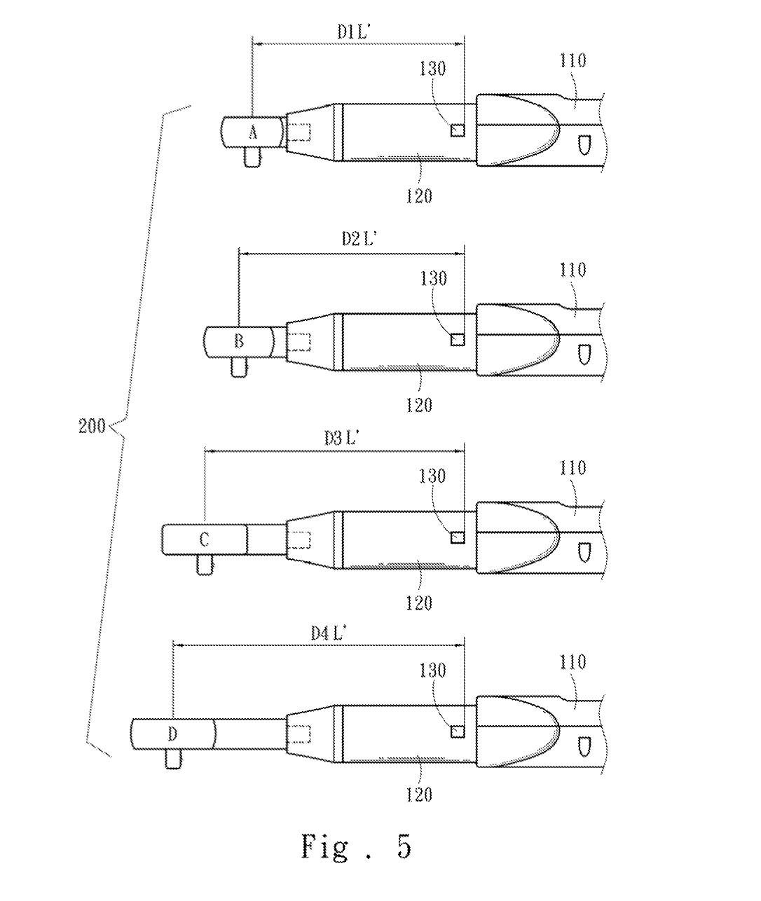

Please refer to FIG. 5, a plurality of drive heads 200 are coupled respectively on another end of the torque bar 120 to wrench a screw (not shown in the drawings). The drive heads 200 are formed at different sizes, hence the distances D1L′, D2L′, D3L′ and D4L′ between the rotary center of the screw and torque detection element 130 are also different. When the drive heads 200 are desired to be changed, the torque displayed on the display element 150 is inconsistent with the actual output torque.

Also referring to FIG. 4, the automatic compensation device 300 includes a torque compensation setting module 310, a torque compensation conversion module 320 and a torque operation range conversion module 330. The automatic compensation device 300 is located in the control system 140. The setting element 160 is electrically connected to the control system 140. Depending on the type of the installed drive head 200, a compensation mode of the torque compensation setting module 310 is set. The torque compensation conversion module 320 and the control system 140 converts and calculates the deformation detected by the torque detection element 130 according to the compensation mode to an actual output torque which is then displayed on the display element 150. Hence no matter what type of the drive head 200 is used, desired compensation can be obtained via the torque compensation conversion module 320 so that the displayed torque of the electronic torque wrench 100 is equal to the actual output torque.

Also referring to FIG. 5, the drive heads 200 are marked respectively with a length symbol D1, D2, D3 and D4 (not shown in the drawings). Through the setting element 160, the length symbols D1, D2, D3 and D4 can be set in the torque compensation setting module 310 according to the length of the drive head 200 to finish compensation setting. In addition, each drive head 200 also can be marked respectively with a specific symbol A, B, C and D that can be corresponding to the length of the drive head 200, or numerals, English characters or graphics. The specific symbols A, B, C and D are corresponding to information for setting the compensation modes through the torque compensation setting module 310. Through the setting element 160, the specific symbols A, B, C and D can be set in the torque compensation setting module 310 according to the used drive head 200 to finish compensation setting. The torque operation range conversion module 330 can convert and change the operable torque range of the electronic torque wrench 100 after the aforesaid compensation setting has been finished to prevent erroneous usage by the user that could result in faulty fastening or damage of the electronic torque wrench 100. When the intended operation target torque set by the user via the setting element 160 exceeds a new operable torque range, the control system 140 of the electronic torque wrench 100 issues an alert signal and displays on the display element 150.

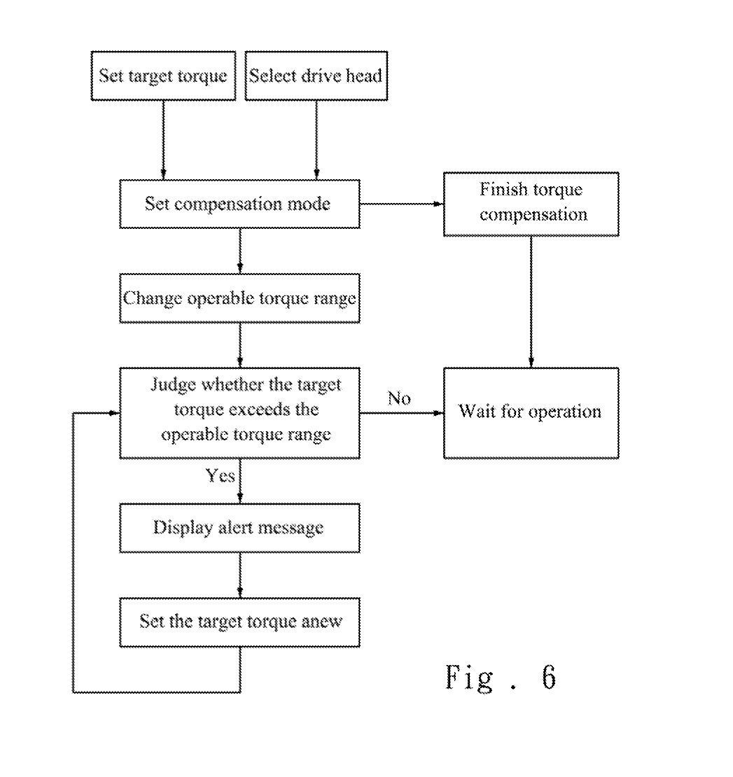

Please refer to FIG. 6 for an operation flow of the invention. First, a user selects a drive head 200 intended to be used, and sets a target torque via the setting element 160; next, a compensation mode is set via the torque compensation setting module 310 according to the selected drive head 200; as discussed previously, the compensation mode is set by inputting the length symbol D1, D2, D3 or D4, or English character A, B, C or D, or a specific symbol. Next, the operable torque range of the electronic torque wrench 100 is changed via the torque operation range conversion module 330. Then judging whether the target torque exceeds the operable torque range; if yes, an alert message is displayed on the display element 150 (greater or smaller than the operable torque range), and the user can set the target torque anew and judge again whether the target torque exceeds the operable torque range; but if the target torque is within the operable torque range, waiting for operation. Meanwhile, after the torque compensation setting module 310 has set the compensation mode according to the selected drive head 200, the torque compensation conversion module 320 finishes torque compensation, and then waiting for operation.

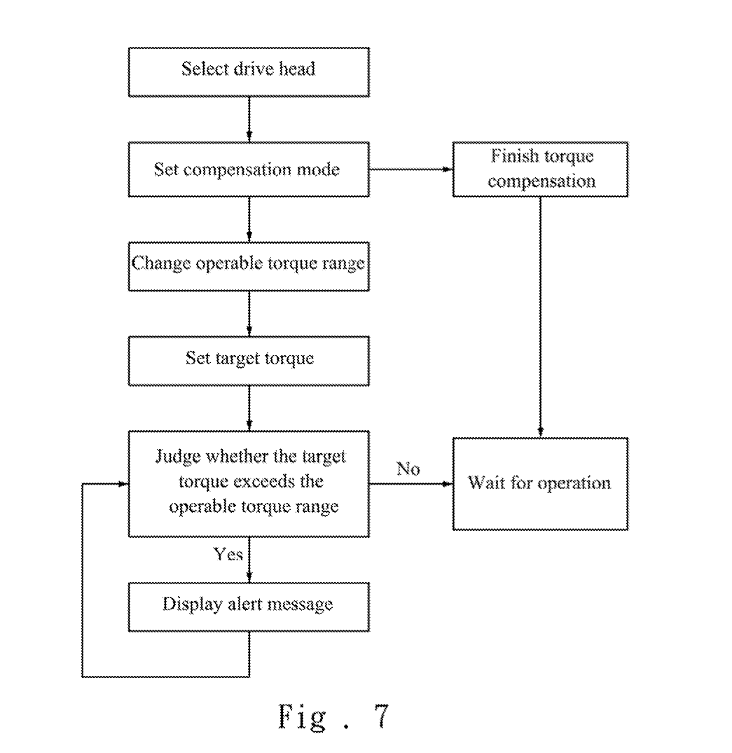

Please refer to FIG. 7 for another operation flow of the invention. First, a user selects a drive head 200 intended to be used, and sets a compensation mode via the torque compensation setting module 310 according to the selected drive head 200; next, the operable torque range of the electronic torque wrench 100 is changed via the torque operation range conversion module 330, and then a target torque is set via the setting element 160. Then judging whether the target torque exceeds the operable torque range; if yes, an alert message is displayed on the display element 150, and the user can set the target torque anew; but if the target torque is within the operable torque range, waiting for operation. Meanwhile, after the torque compensation setting module 310 has set the compensation mode according to the selected drive head 200, the torque compensation conversion module 320 finishes torque compensation, and then waiting for operation.

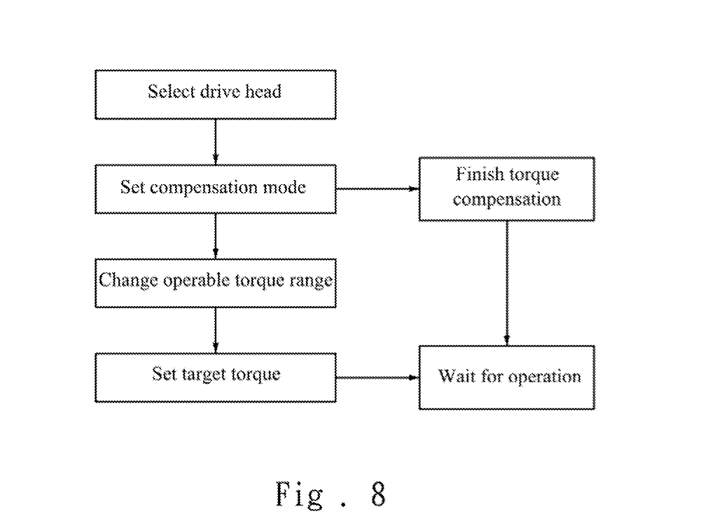

Please refer to FIG. 8 for a simplified operation flow of the invention. First, a user selects a drive head 200 intended to be used; next, a compensation mode is set via the torque compensation setting module 310 according to the selected drive head 200; next, the operable torque range of the electronic torque wrench 100 is changed via the torque operation range conversion module 330, and then a target torque is set via the setting element 160, and waiting for operation. Meanwhile, after the torque compensation setting module 310 has set the compensation mode according to the selected drive head 200, the torque compensation conversion module 320 finishes torque compensation, and then waiting for operation.

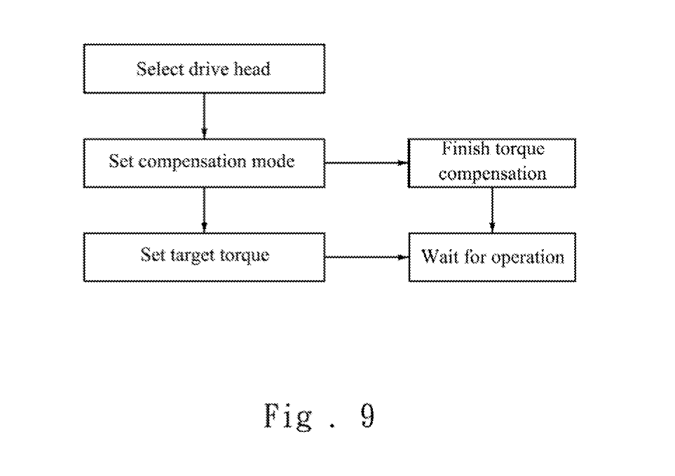

Please refer to FIG. 9 for another simplified operation flow of the invention. First, a user selects a drive head 200 intended to be used; next, a compensation mode is set via the torque compensation setting module 310 according to the selected drive head 200; next, a target torque is set via the setting element 160, and waiting for operation. Meanwhile, after the torque compensation setting module 310 has set the compensation mode according to the selected drive head 200, the torque compensation conversion module 320 finishes torque compensation, and then waiting for operation.

As a conclusion, in the invention, after different drive heads 200 have been changed, and the automatic compensation device 300 has performed operation, calculation and compensation, the target torque of the electronic torque wrench 100 can be equal to the displayed torque and the actual output torque, thereby can avoid formula calculation trouble and errors, and also improve usability, accuracy and reliability.

What is claimed is:

1. An electronic torque apparatus equipped with an automatic compensation device with output torque, comprising:
an electronic torque wrench;
a torque compensation setting module to set a compensation mode; and
a torque compensation conversion module to calculate and convert compensation via the compensation mode to allow display torque equal to output torque during operation of the electronic torque wrench.

2. The electronic torque apparatus of claim 1, wherein the electronic torque wrench includes at least one changeable drive head.

3. The electronic torque apparatus of claim 2, wherein the drive head includes at least one specific symbol according to a type thereof that is corresponding to information for setting the compensation mode through the torque compensation setting module.

4. The electronic torque apparatus of claim 3, wherein the at least one specific symbol is a corresponding length of the drive head.

5. An electronic torque apparatus equipped with an automatic compensation device with output torque, comprising:
an electronic torque wrench;
a torque compensation setting module to set a compensation mode;
a torque operation range conversion module to calculate and convert compensation via the compensation mode and change operable torque range of the electronic torque wrench; and
a torque compensation conversion module to calculate and convert the compensation via the compensation mode to allow display torque equal to output torque during operation of the electronic torque wrench.

6. The electronic torque apparatus of claim 5, wherein the electronic torque wrench issues an alert message when a preset operation target torque falls beyond the operable torque range of the electronic torque wrench.

7. The electronic torque apparatus of claim 5, wherein the electronic torque wrench includes at least one changeable drive head.

8. The electronic torque apparatus of claim 7, wherein the drive head includes at least one specific symbol according to a type thereof that is corresponding to information for setting the compensation mode through the torque compensation setting module.

9. The electronic torque apparatus of claim 8, wherein the at least one specific symbol is a corresponding length of the drive head.

10. An operation method for an electronic torque apparatus equipped with an automatic compensation device with output torque, comprising steps of:
selecting a drive head intended to be used;
setting a compensation mode through a torque compensation setting module according to the selected drive head;
changing an operable torque range of an electronic torque wrench through a torque operation range conversion module;
setting a target torque through a setting element and then waiting for operation; and
finishing torque compensation through a torque compensation conversion module after the torque compensation setting module has set the compensation mode according to the selected drive head, and then waiting for operation.
